(19) United States
(12) Patent Application Publication
(10) Pub. No.: US 2026/0087519 A1
(43) Pub. Date: Mar. 26, 2026

(54) INFORMATION PROCESSING DEVICE AND INFORMATION PROCESSING METHOD

(71) Applicant: Toshiba Tec Kabushiki Kaisha, Tokyo (JP)

(72) Inventors: Takuji SAKAGUCHI, Katsushika Tokyo (JP); Toru OGAWA, Izunokuni Shizuoka (JP)

(21) Appl. No.: 19/270,055

(22) Filed: Jul. 15, 2025

(30) Foreign Application Priority Data
Sep. 25, 2024 (JP) 2024-166404

(51) Int. Cl. G06Q 30/0251

(52) U.S. Cl. CPC G06Q 30/0257; G06Q 30/0253

(57) ABSTRACT

According to one embodiment, an electronic receipt server includes a communication interface, a storage device, and a processing circuit. The processing circuit is configured to receive advertisement setting information from a setter terminal via the communication interface, store the advertisement setting information in the storage device, store electronic receipt information in the storage device, and receive a request for an electronic receipt from a user terminal via the communication interface. The processing circuit identifies a company code associated with the requested electronic receipt, then acquires the advertisement setting information associated with the company code in the storage device and determines whether the advertisement setting information indicates company-specific advertisements are enabled for the company code. The processing circuit then acquires a company-specific advertisement when the advertisement information indicates company-specific advertisements are enabled for the company code and outputs the acquired company-specific advertisement with the electronic receipt to the user terminal.

### CROSS-REFERENCE TO RELATED APPLICATION

This application is based upon and claims the benefit of priority from Japanese Patent Application No. 2024-166404, filed Sep. 25, 2024, the entire contents of which are incorporated herein by reference.

### FIELD

Embodiments described herein relate generally to an information processing device and an information processing method.

### BACKGROUND

An electronic receipt service is known in which a transaction receipt indicating content of a transaction settled at a checkout machine, such as a point of sales (POS) terminal, can be digitized to be viewed by an electronic receipt service user on a mobile terminal or the like.

For companies using such an electronic receipt service, there may be a demand to display an advertisement along with the electronic receipt obtained by digitizing a transaction receipt.

### BRIEF DESCRIPTION OF THE DRAWINGS

FIG. 1 is a block diagram showing an information processing system according to an embodiment.

FIG. 2 is a block diagram showing a server.

FIG. 3 is a sequence diagram showing a procedure for setting information.

FIG. 4 is a sequence diagram showing a procedure for electronic receipt distribution.

FIG. 5 is a a flowchart of electronic receipt distribution processing performed by a server.

FIG. 6 is a diagram showing a display example for a setter terminal.

FIG. 7 is a diagram showing a display example for a user terminal.

FIG. 8 is a flowchart showing a modification of a procedure of electronic receipt distribution processing.

### DETAILED DESCRIPTION

Provided is an technological improvement permitting advertisements to be selected by a company that uses an electronic receipt service to be displayed to users of the electronic receipt service. Embodiments represent technological solutions to existing problems in the related art of electronic receipt services and the like.

In general, according to one embodiment, an electronic receipt server includes a communication interface connectable to a network, a storage device, and a processing circuit. The processing circuit is configured to: receive advertisement setting information from a setter terminal via the communication interface; store the advertisement setting information in the storage device; store electronic receipt information in the storage device; receive a request for an electronic receipt from a user terminal via the communication interface; identify a company code associated with the requested electronic receipt; acquire the advertisement setting information associated with the company code n the storage device; determine whether the advertisement setting information indicates company-specific advertisements are enabled for the company code; acquire a company-specific advertisement when the advertisement information indicates company-specific advertisements are enabled for the company code; and output acquired company-specific the advertisement with the electronic receipt to the user terminal via the communication interface.

### Example Embodiment

Hereinafter, certain example embodiments will be described with reference to the drawings. The examples are non-limiting and provided for the purposes of clearer explanation of aspects of the present disclosure.

Hereinafter, an information processing system that provides an electronic receipt service that digitizes a transaction receipt representing content of a sakes transaction settled at a POS terminal or the like will be explained. A digitized transaction receipt may also be referred to as an electronic receipt in some contexts.

Sales transaction related to a commodity is a payment from a customer to a store for the selling of the commodity by the store to the customer. In present context, a sales transaction includes sales and purchases of commodities. In present context, reference to the selling of a commodity includes not only tangible merchandise (items) but also a non-tangible items such as a service or a ticket provided to the customer (purchaser). The store in the present examples may be one that mainly sells tangible goods or one that mainly sells services. A store mainly sells tangible commodities may be a supermarket or a home center, but is not limited thereto. A store that mainly sells services may be a restaurant or a sports gym, but is not limited thereto. The store of an example may be a physical store or an electronic commerce (EC) store.

For example, the store may be operated by a retailer. The retailer may be of any genre. The retailer may operate a plurality of stores. A retailer may be one in a group of retailers that operates stores as affiliates or franchisees. For example, the group of retailers may operate stores under the same name.

The group retailers may be franchisees engaged with a franchisor. The retailer is one example of a company that uses or adopts an electronic receipt service.

### Configuration Example

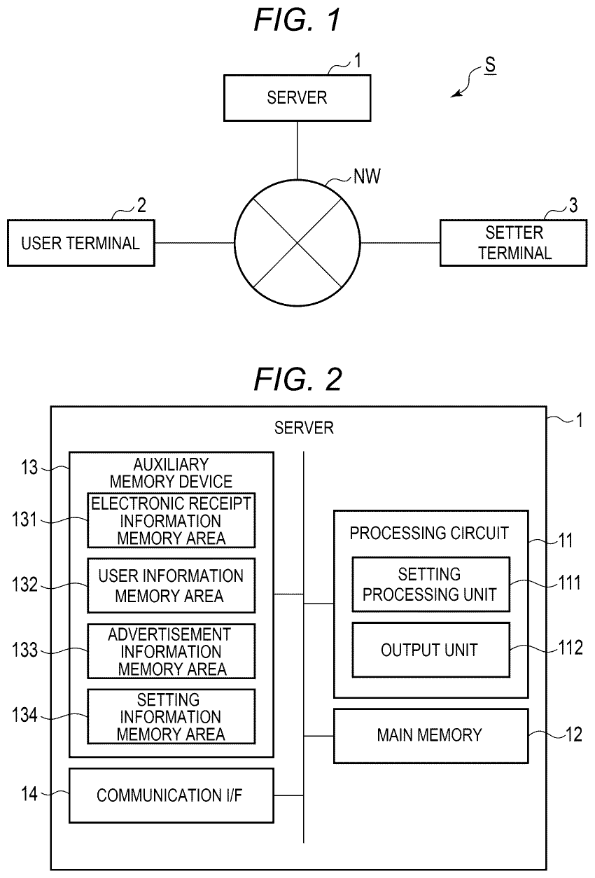

FIG. 1 is a block diagram showing an information processing system S.

The information processing system S includes a server 1, a user terminal 2, and a setter terminal 3. The server 1, the user terminal 2, and the setter terminal 3 are communicably connected to one another via a network NW. The network NW may include one or more networks such as the Internet, a mobile communication network, and a local area network (LAN). The one or more networks may include a wireless network or a wired network.

In some examples, an information processing system S may be a system including the server 1 and at least one of the user terminal 2 and the setter terminal 3.

The server 1 is a computer device or the like capable of communicating with the user terminal 2 and the setter terminal 3 via the network NW. The server 1 stores various types of information. In this example, the server 1 provides an electronic receipt service. The server 1 is an example of an information processing device. The server 1 may be a server provided as a cloud service or the like.

The server 1 stores various information necessary for providing the electronic receipt service. For example, the server 1 stores user information of the service users who use the electronic receipt service. In the following description, a service user may be referred to as a user, a customer, a consumer, a shopper, a store member, an electronic receipt service member, or the like. The server 1 stores electronic receipt information used for dispensing an electronic receipt. In present context, an electronic receipt is a digital or digitized receipt that can be displayed on a terminal as a receipt image that is based on the electronic receipt information.

The user terminal 2 can be any device capable of communicating with another device. The user terminal 2 is, for example, a mobile device of a user who uses the electronic receipt service. In the following, a case in which a user performs shopping at a store (“store X”) and receives a transaction receipt as an electronic receipt instead of a paper receipt will be described. For example, the user operates the user terminal 2 to activate an application program for the electronic receipt service. The application program for the electronic receipt service is assumed to be stored in the user terminal 2. In some examples, the application program of the electronic receipt service may be an application program set for each retailer separately. That is, a dedicated store/retailer application program may be provided with an electronic receipt function rather than requiring a separate/dedicated electronic receipt service application. The electronic receipt functionality of retailer specific application program can include an electronic receipt dispensing function and an electronic receipt display function. In some examples, the user displays a member code associated with the electronic receipt on the user terminal 2 via the application program on the user terminal 2. The user can thus receive an electronic receipt by causing the POS terminal at the store X to read the displayed (or otherwise presented) member code. The user terminal 2 can then receive and display the dispensed electronic receipt on a display device. For example, the user of the user terminal 2 activates the electronic receipt display function of an application program and a receipt image corresponding to the electronic receipt is displayed on a display device. For example, the user terminal 2 is a smartphone or a tablet terminal.

The setter terminal 3 can be any device that can be used by a setter (e.g., store administrator) to perform advertisement settings for the advertisements to be displayed on, or otherwise in conjunction with, an electronic receipt. The setter terminal 3 includes an input device capable of inputting information. The setter terminal 3 includes a display device capable of displaying an image. The setter terminal 3 includes a communication interface that communicably connects the setter terminal 3 to other devices via the network NW. The setter terminal 3 may be a personal computer (PC), a tablet terminal, a smartphone, or the like. The setter terminal 3 may be a dedicated device or one with other uses. The setter can be any user of the setter terminal 3. The setter may be a store owner, an administrator of the electronic receipt service, or the like.

A configuration example of the server 1 will be described.

FIG. 2 is a block diagram showing the server 1.

The server 1 includes a processing circuit 11, a main memory 12, an auxiliary memory device 13, and a communication interface 14. Respective units constituting the server 1 are connected to each other such that signals can be input and output therebetween. In FIG. 2, the communication interface is labeled as “communication I/F”.

The processing circuit 11 corresponds to a central part of the server 1. The processing circuit 11 may be one or more circuits that execute a plurality of processing using a plurality of functions. For example, the circuit is a processor, an application specific integrated circuit (ASIC), or a field-programmable gate array (FPGA), but is not limited thereto. For example, the processor is a central processing unit (CPU) or a graphics processing unit (GPU), but is not limited thereto. The processing circuit 11 loads a program stored in the main memory 12 or the auxiliary memory device 13 into the main memory 12. The program provides instructions for causing the processing circuit 11 to execute processing for providing the functions of server 1 to be further described below The processing circuit 11 executes a program loaded into the main memory 12 to enable execution of various types of processing.

The main memory 12 includes a non-volatile memory area and a volatile memory area. The main memory 12 stores an operating system or a program in the non-volatile memory area. The main memory 12 uses the volatile memory area as a work area in which data is appropriately rewritten by the processing circuit 11. For example, the main memory 12 includes a read only memory (ROM) as the non-volatile memory area. For example, the main memory 12 includes a random access memory (RAM) as the volatile memory area.

The auxiliary memory device 13 includes one or more memory devices. Examples of a memory device include an electric erasable programmable read-only memory (EEPROM), a hard disc drive (HDD), a solid-state drive (SSD), and a flash memory, but are not limited thereto. The auxiliary memory device 13 stores the above-described program, data used by the processing circuit 11 to perform various types of processing, and data generated by the processing circuit 11.

The auxiliary memory device 13 includes an electronic receipt information memory area 131. The electronic receipt information memory area 131 stores the electronic receipt information. The electronic receipt information is data for implementing an electronic receipt. The electronic receipt information is transaction data of a transaction settled at a POS terminal or the like. The electronic receipt indicates details of a transaction and corresponds, in general, to the content provided by a traditional paper receipt or the like. For example, details of a transaction include information related to items (commodities) purchased in the transaction, information about the store at which the transaction was performed, and information related to a transaction date and time. The details of the transaction may include information other than the above information. For example, the information related to a purchased commodity may include all or a part of a name of the commodity, a transaction price, a transaction quantity, and a transaction amount obtained by multiplying the transaction price and the transaction quantity. The information related to the purchased commodity may include information other than the above information. The information related to the store in which the transaction was performed can include a name of the store.

The electronic receipt information can include data for the following items: an electronic receipt number, a terminal number, a transaction number, a transaction date and time, a company code, a company name, a store code, a store name, a commodity code, a commodity name, a unit price, a quantity, and a receipt total amount. The electronic receipt number is a code capable of uniquely identifying the electronic receipt. The terminal number is information indicating an identification number of a POS terminal or the like at which transaction processing was performed. The transaction number is a code capable of uniquely identifying a transaction. The transaction date and time is a date and time of the transaction. The company code is a code capable of uniquely identifying the retailer who operates the store at which the transaction was performed. The company name is a name of a retailer. The store code is a code capable of uniquely identifying the store at which the transaction was performed. The store name is a name of the store. The commodity code is a code capable of uniquely identifying a commodity in the transaction. The commodity name is a name of the commodity. The unit price is a price per unit of a purchased commodity. The quantity is the number of purchased commodities. The receipt total amount is a total amount obtained by summing up transaction amounts of purchased commodities in a transaction. The electronic receipt information may include data on items other than the above-described items.

The electronic receipt information memory area 131 is updated by adding, updating, or deleting the electronic receipt information as appropriate. The electronic receipt information memory area 131 is an example of a memory that stores the electronic receipt information.

The auxiliary memory device 13 includes a user information memory area 132. The user information memory area 132 stores user information. The user information indicates member information of members of the electronic receipt service. The user information includes, for example, a member ID, a member code, and attribute data. The member ID is, for example, a code capable of uniquely identifying a customer as a member of an electronic receipt service. The member ID may be a code capable of uniquely identifying a customer as a member of a store (e.g., a member of a store loyalty program). The member code can be an ID code indicating a member ID. The attribute data may include data such as a name, a date of birth, an address, a gender, and a family status or structure. The attribute data may include data about a member rank indicating a type of a member. The user information may include point data (e.g., accumulated loyalty program reward points). The user information memory area 132 is updated by adding, updating, or deleting the user information as appropriate. The user information memory area 132 is an example of a memory that stores the user information.

The auxiliary memory device 13 includes an advertisement information memory area 133. The advertisement information memory area 133 stores advertisement information. The advertisement information is information related to an advertisement to be displayed on or with an electronic receipt. An advertisement can be a company-specific advertisement set for each retailer. A company-specific advertisement can be an advertisement related to a specific company or a specific retailer. A company-specific advertisement is, for example, an advertisement set differently for each company. A company-specific advertisement includes, for example, sales promotion information related to a specific store or a specific company. Sales promotion information includes, for example, information about store-specific events, company-wide campaigns, rewards, or private brand commodities. The advertisement may be a common advertisement distributed among multiple retailers. A common advertisement may be a general-purpose advertisement or a non-retailer specific advertisement. A common advertisement is, for example, one not related to any specific retailer in particular. A common advertisement may be a questionnaire. In the following description, “distribution” may be interpreted as “transmission”, “output”, or “provision”.

The advertisement information includes, for example, data such as advertisement identification information and an advertisement image. The advertisement identification information is, for example, information capable of uniquely identifying a particular advertisement. The advertisement identification information may be, for example, information that wishes identifying a retailer to distribute the advertisement. The information for identifying the retailer is, for example, a company code. The advertisement identification information may be a combination of information for identifying a retailer and information for identifying an advertisement. In this context, an advertisement image is image data for displaying an advertisement. The advertisement image may include, for example, text, graphics, pictures, and/or video. The advertisement image may be an image format the same as an electronic receipt image or may be another image format. The advertisement image may be incorporated in, or with, an electronic receipt image. The advertisement information may include information for identifying an output destination. The information for identifying the output destination may be related to, for example, attribute information such as a member rank of a member involved in the transaction. The output destination indicates a user to whom the advertisement is to be distributed. The output destination is also referred to as an advertisement distribution destination. The advertisement information memory area 133 is updated by adding, updating, or deleting the advertisement information as appropriate. The advertisement information memory area 133 is an example of a memory that stores the advertisement information.

The auxiliary memory device 13 includes a setting information memory area 134. The setting information memory area 134 stores advertisement setting information. The advertisement setting information is information about an advertisement setting related to an advertisement to be displayed on or with the electronic receipt. The advertisement setting is a setting (parameter) related to an advertisement that may be set for each retailer separately. The advertisement setting information includes data such as a company code, a company name, a company-specific advertisement setting, and advertisement identification information. The company-specific advertisement setting is a setting related to distribution of a company-specific advertisement. The setting related to the distribution of the company-specific advertisement includes information indicating whether to output a company-specific advertisement. The information indicating whether to output the company-specific advertisement may be a flag value for the distribution of company-specific advertisements. The setting value can enable or disable the output of company-specific advertisements. The company-specific advertisement is an example of an advertisement for appropriate for a particular company but not others. The setting information memory area 134 is updated by adding, updating, or deleting the advertisement setting information as appropriate. The setting information memory area 134 is an example of a memory that stores setting information. The advertisement setting information is also more simply referred to as setting information.

The communication interface 14 can be various interfaces that communicably connect the server 1 to other devices via the network NW according to a predetermined communication protocol.

The hardware configuration of the server 1 is not limited to the above-described configuration.

Each functional unit implemented by the processing circuit 11 of store server 1 will now be described.

The processing circuit 11 implements a setting processing unit 111 and an output unit 112. Each unit implemented by the processing circuit 11 can also be referred to as a function. Each unit implemented by the processing circuit 11 can also be referred to as being implemented by a control unit or the like including the processing circuit 11 and the main memory 12.

The setting processing unit 111 performs an advertisement setting for an advertisement to be displayed on the electronic receipt. For example, the setting processing unit 111 acquires the advertisement setting information from the setter terminal 3 via the communication interface 14. The setting processing unit 111 then performs the advertisement setting by storing the advertisement setting information in the setting information memory area 134. Performing the advertisement setting includes enabling the output of company-specific advertisement.

The output unit 112 performs electronic receipt distribution processing. The electronic receipt distribution processing includes outputting an electronic receipt. For example, the output unit 112 outputs advertisement display data via the communication interface 14 based on the advertisement setting information for displaying an advertisement on (or with) the electronic receipt. The advertisement display data can include common advertisement display data. The common advertisement display data is data for displaying a common (shared) advertisement on the electronic receipt. The common advertisement display data includes at least one of text data, image data, and video data. The advertisement display data can include company-specific advertisement display data. The company-specific advertisement display data is data for displaying a company-specific advertisement on (or with) the electronic receipt. The company-specific advertisement display data includes at least one of text data, image data, and video data. Displaying an advertisement includes displaying the advertisement as a part of the electronic receipt. Displaying an advertisement includes displaying the advertisement separately from the electronic receipt. Displaying an advertisement includes displaying the electronic receipt and the advertisement as a connected list or the like.

Here, the electronic receipt electronically indicates information related to a transaction such as details of the transaction. Displaying the electronic receipt refers to displaying an image indicating information related to the transaction. Displaying an advertisement on the electronic receipt includes displaying an image indicating the advertisement in addition to the electronic receipt.

For example, the output unit 112 acquires a receipt display command from the user terminal 2 via the communication interface 14. The receipt display command is, for example, a command for displaying an electronic receipt. The receipt display command includes user identification information and electronic receipt identification information. The user identification information is, for example, a member ID. The electronic receipt identification information is, for example, an electronic receipt number. The electronic receipt identification information may be a transaction number. The receipt display command may include company identification information. The company identification information is, for example, a company code. The receipt display command may also include the advertisement identification information. The output unit 112 then outputs the electronic receipt based on the received receipt display command.

The output unit 112 performs advertisement distribution processing based on the advertisement setting information. If the advertisement setting information indicates that an advertisement for a company is to be output, the output unit 112 outputs the company-specific advertisement display data for the company via the communication interface 14. If the advertisement setting information does not include the setting for outputting a company specific advertisement, the output unit 112 outputs common advertisement display data via the communication interface 14.

The output unit 112 outputs, via the communication interface 14, the advertisement display data for displaying an advertisement for a particular company in a manner identifiable from other advertisements. For example, the output unit 112 may output the company-specific advertisement display data for displaying the company-specific advertisement in a manner identifiable from a common advertisement. The identifiable manner includes a mode in which a display area or a display position is different from that of a common advertisement. The identifiable manner include use of different display sizes. The identifiable manner includes a mode in which a text (font) color, a text decoration, such as brightness or luminance, a background color, brightness or luminance of a background, a background pattern, a frame color, a blinking display, or the like is different from that of a common advertisement. For example, the output unit 112 may output the company-specific advertisement display data to display in a display area different from that of a common advertisement. The different display area is, for example, a display area above an area in which the common advertisement is normally displayed.

### Processing Example

Processing of the information processing system S will be described.

In the following description, operations or functions of server 1 may also or instead be considered as operations or functions of the processing circuit 11. Similarly, operations or functions of the user terminal 2 may also or instead be considered as those of a processing circuit of the user terminal 2. Likewise, operations or functions of setter terminal 3 may also or instead be considered as those of a processing circuit of the setter terminal 3.

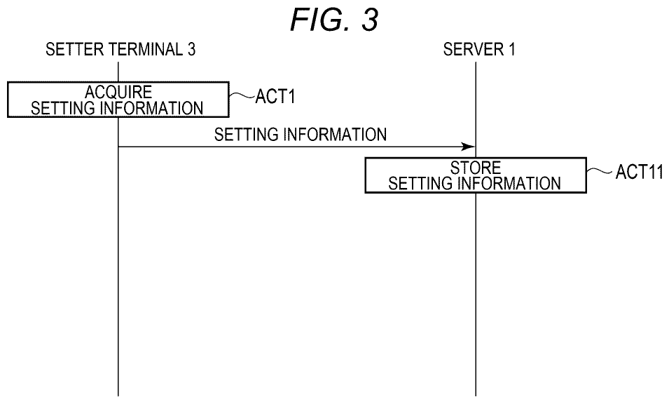

FIG. 3 is a sequence diagram showing a procedure of information processing for the setting information of the information processing system S according to an embodiment. FIG. 3 shows a procedure for performing the advertisement setting.

The setter terminal 3 acquires advertisement setting information based on a user operation (ACT1). In ACT1, for example, the setter terminal 3 receives, from a setter or the like, an advertisement setting related to an advertisement to be displayed on an electronic receipt. Here, a user operation for making an advertisement setting is an input operation by a setter using an input device of the setter terminal 3. For example, the setter inputs the advertisement setting information via an advertisement setting screen. For example, the setter inputs a company code, a company name, a company-specific advertisement setting, and advertisement identification information. The setter may check a box or the like for making the company-specific advertisement setting on the advertisement setting screen. In this example, the checking of the box for the company-specific advertisement setting indicates that the output of the company-specific advertisement is enabled.

The setter terminal 3 then outputs the advertisement setting information to the server 1.

The server 1 acquires the advertisement setting information from the setter terminal 3 via the communication interface 14. The server 1 stores the advertisement setting information in the setting information memory area 134 (ACT11).

As described above, the setter terminal 3 can set the advertisement setting information based on a user operation. Accordingly, the server 1 output of company-specific advertisement for an electronic receipt can be set according to a user operation. By outputting the advertisement based on the advertisement setting information, the server 1 can distribute an electronic receipt for displaying an advertisement for different companies according to preference of each company or the like.

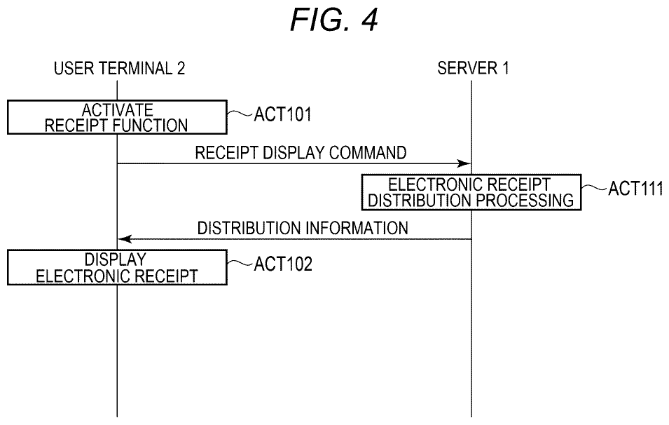

FIG. 4 is a sequence diagram showing a procedure of information processing for electronic receipt distribution of the information processing system S according to an embodiment.

In the following, it is assumed that the user of the user terminal 2 activates an application program already installed in the user terminal 2 and then performs a request operation for requesting an electronic receipt. The application program may be, for example, an application program dedicated to the electronic receipt service or an application program that provides a service including an electronic receipt function. In the following example, the user of the user terminal 2 installs and then activates an application program dedicated to a retailer service including the electronic receipt function. The application program dedicated to the retailer service includes functions such as the electronic receipt function and a point tracking service function.

The electronic receipt function is activated on the user terminal 2 based on the user operation (ACT101). The user operation is, for example, selecting a button for displaying an electronic receipt from a home screen of the application program by a touch input or the like. In ACT101, the user terminal 2 receives a receipt display command based on the user operation. The user terminal 2 then outputs the receipt display command to the server 1. The user terminal 2 may output company identification information to the server 1 at this time. In some examples, the company identification information may be output to the server 1 when the application program dedicated to a particular retailer service is activated.

The server 1 acquires the receipt display command from the user terminal 2 via the communication interface 14. The server 1 performs electronic receipt distribution processing based on the received receipt display command (ACT111). The processing of ACT111 may be performed by the output unit 112 implemented by the processing circuit 11. In the present example, the server 1 performs the electronic receipt distribution processing based on the advertisement setting information.

The server 1 outputs distribution information for the electronic receipt to the user terminal 2 via the communication interface 14. The distribution information includes electronic receipt display data for displaying the electronic receipt. The distribution information also includes advertisement display data for displaying an advertisement on the electronic receipt.

The user terminal 2 acquires the distribution information from the server 1. The user terminal 2 displays the electronic receipt on its display device (ACT102). In ACT102, the user terminal 2 displays an electronic receipt image on its display device according to the electronic receipt display data. The user terminal 2 also displays an advertisement image on its display device based on the advertisement display data. In one example, the user terminal 2 acquires common advertisement display data. The user terminal 2 thus displays a common advertisement image on its display device based on the received common advertisement display data. In another example, the user terminal 2 acquires company-specific advertisement display data for displaying a company-specific advertisement. The user terminal 2 displays the company-specific advertisement image on its display device based on the received company-specific advertisement display data. For example, the user terminal 2 displays the company-specific advertisement image on its display device in a manner different from that used for a common advertisement image.

As described above, the server 1 can output the electronic receipt display data to the user terminal 2 based on the user operation at the user terminal 2. The server 1 can output the advertisement display data to the user terminal 2 based on the corresponding advertisement setting information. Accordingly, the user terminal 2 can display the electronic receipt and an advertisement on its display device. Whether common (non-company-specific) advertisement or a company-specific advertisement is shown at the user terminal 2 is decided based on the setting information stored on the server 1.

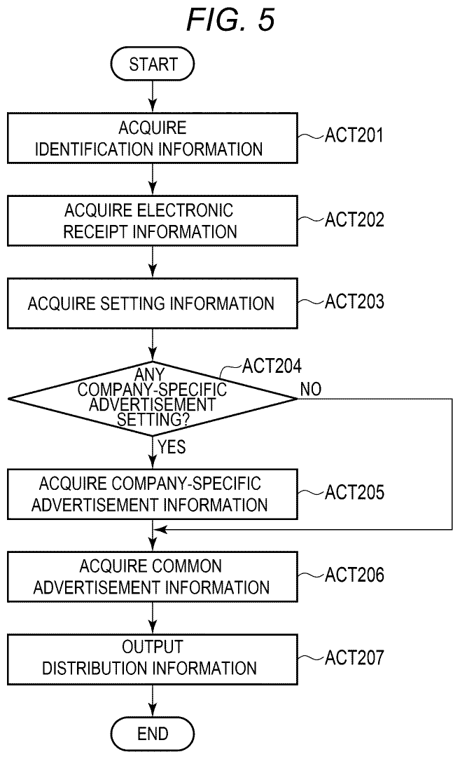

FIG. 5 is a flowchart of the electronic receipt distribution processing performed by the server 1 according to an embodiment.

The following processing corresponds, in general, to the electronic receipt distribution processing of ACT111 in FIG. 4. The server 1 acquires the receipt display command from the user terminal 2. The receipt display command includes the user identification information and the electronic receipt identification information. The server 1 acquires the company identification information from the user terminal 2.

The processing circuit 11 acquires identification information (ACT201). The ACT201 processing may be performed by the output unit 112 implemented by the processing circuit 11. In ACT201, the processing circuit 11 acquires a user ID and an electronic receipt number from the server 1 based on the receipt display command. The processing circuit 11 also acquires a company code from the server 1.

The processing circuit 11 acquires the electronic receipt information based on the electronic receipt number (ACT202). The ACT202 processing may be performed by the output unit 112 implemented by the processing circuit 11. In ACT202, the processing circuit 11 acquires the electronic receipt information from the electronic receipt information memory area 131 as identified by the electronic receipt number.

The processing circuit 11 acquires the advertisement setting information (ACT203). The ACT203 processing may be performed by the output unit 112 implemented by the processing circuit 11. In ACT203, the processing circuit 11 acquires, based on the company code, the advertisement setting information of the retailer identified by the company code from the setting information memory area 134.

Based on the advertisement setting information, the processing circuit 11 determines whether a company-specific advertisement setting was performed (ACT204). The ACT204 processing may be performed by the output unit 112 implemented by the processing circuit 11. In ACT204, the processing circuit 11 refers to information about the company-specific advertisement settings. If the company-specific advertisement setting indicates that the company-specific advertisement is to be output, the processing circuit 11 determines that the company-specific advertisement setting was made (is enabled). If the company-specific advertisement setting does not indicate that a company-specific advertisement is to be output, the processing circuit 11 determines that the company-specific advertisement setting was not made (is not enabled).

If a company-specific advertisement setting was made (ACT204: YES), the processing transitions from ACT204 to ACT205. If a company-specific advertisement setting was not made (ACT204: NO), the processing transitions from ACT204 to ACT206.

The processing circuit 11 acquires the company-specific advertisement information (ACT205). The ACT205 processing may be performed by the output unit 112 implemented by the processing circuit 11. In ACT205, the processing circuit 11 refers to the advertisement setting information and acquires the advertisement identification information. The processing circuit 11 acquires the advertisement information corresponding to the advertisement identification information from the advertisement information memory area 133. For example, the processing circuit 11 acquires company-specific advertisement image data for displaying a company-specific advertisement.

The processing circuit 11 acquires the common advertisement information (ACT206). The ACT206 processing may be performed by the output unit 112 implemented by the processing circuit 11. In ACT206, the processing circuit 11 acquires the common advertisement information from the advertisement information memory area 133. For example, the processing circuit 11 acquires common advertisement image data for displaying a common advertisement. In some examples, processing circuit 11 may randomly acquire the common advertisement information from a plurality of pieces of available common advertisement information. In some examples, processing circuit 11 may acquire the common advertisement information based on a ordering or preference setting of an administrator or the like.

The processing circuit 11 outputs the distribution information to the user terminal 2 via the communication interface 14 (ACT207). The ACT207 processing may be performed by the output unit 112 implemented by the processing circuit 11. In ACT207, the processing circuit 11 outputs the electronic receipt information to the user terminal 2. The processing circuit 11 outputs the advertisement display data to be displayed on the electronic receipt to the user terminal 2. For example, when the output of the company-specific advertisement is enabled, the processing circuit 11 outputs both the company-specific advertisement image data and the common advertisement image data to the user terminal 2. When the output of the company-specific advertisement is disabled, the processing circuit 11 outputs just the common advertisement image data to the user terminal 2.

According to the present example, the server 1 can perform an advertisement setting related to the advertisement to be displayed on the electronic receipt and output the advertisement display data for displaying the advertisement on the electronic receipt based on the advertisement setting. For example, the server 1 advertisement setting information can be set separately each company and then advertisements may be output to the user terminal 2 based on the advertisement setting information for each company. Accordingly, the server 1 can distribute an advertisement as desired by each company adopting the electronic receipt service. For example, the retailer can distribute a desired advertisement to the user who browses an electronic receipt related to a purchase at the retailer. The user terminal 2 can display the advertisement on the electronic receipt based on the advertisement setting information set for each company or retailer.

The server 1 can select which electronic receipt advertisement to output for each company/retailer, as such, the server 1 can output a company-specific advertisement as desired. The user terminal 2 can thus distribute advertisements as desired by each company using the electronic receipt service. The user of the user terminal 2 can receive an advertisement specifically related to the store at which the transaction related to the electronic receipt was performed or for a retailer brand/company related to store.

If the setting related does not include a setting for outputting a company-specific advertisement for a particular company, the server 1 can still output a common advertisement in association with an electronic receipt. Therefore, if a retailer does not want the server 1 to output a company-specific advertisement with the electronic receipts associated with the retailer, the server 1 can output data for displaying a common (shared) advertisement image along with the electronic receipt for the retailer. For example, the server 1 can distribute a general-purpose advertisement not specifically related to the retailer. The server 1 can thus cause a common advertisement to be displayed even when a company/retailer does not request a company-specific advertisement to be presented with an electronic receipt associate with the company/retailer. The user terminal 2 can thus still display a general-purpose advertisement on the electronic receipt.

The server 1 can output the advertisement display data for each company in a mode identifiable from other advertisements. For example, the server 1 can output advertisement display data for displaying the company-specific advertisement in a display mode or manner different from that of the common advertisement. For example, the server 1 can output the advertisement display data so that the company-specific advertisement is displayed above the common advertisement. Accordingly, the server 1 can make the company-specific advertisement more noticeable than the common advertisement. The user terminal 2 can display the company-specific advertisement in a display mode different from that of the common advertisement. Accordingly, the user may pay more attention to the company-specific advertisement.

The advertisement setting screen of the advertisement setting information will be described.

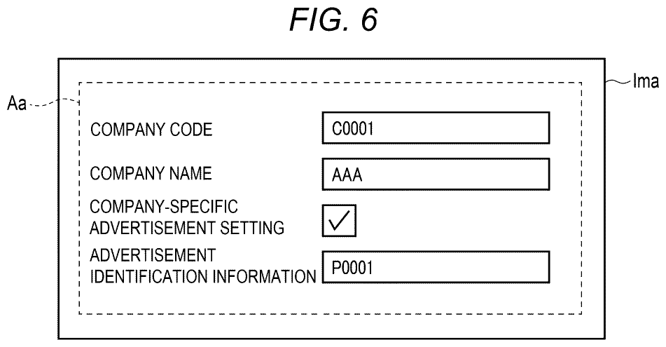

FIG. 6 is a diagram showing an advertisement setting image Ima displayed on the display device of the setter terminal 3. The advertisement setting image Ima is used for inputting the advertisement setting information. The advertisement setting image Ima includes an advertisement setting information input area Aa.

The advertisement setting information input area Aa is an area for inputting a company code, a company name, a company-specific advertisement setting, and advertisement identification information. For example, the setter inputs a company code “C0001” and a company name “AAA” via an input device. The setter checks a check box for the company-specific advertisement setting via the input device. The check box is checked to indicate that the company-specific advertisement setting is enabled.

Accordingly, the setter can set whether to output a company-specific advertisement. The setter terminal 3 outputs the advertisement setting information to the server 1.

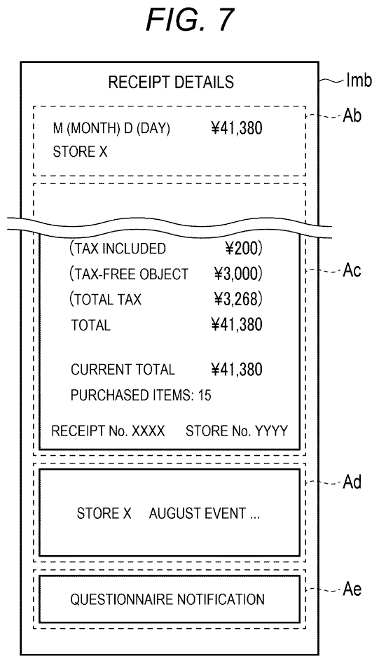

A display example of an electronic receipt will be described. FIG. 7 is a diagram showing an electronic receipt image Imb displayed on the display device of the user terminal 2. The electronic receipt image Imb is an electronic receipt image to be displayed when a specific receipt is selected from a receipt list image displayed after an electronic receipt function is activated. The electronic receipt image Imb has a selected receipt display area Ab, a receipt detail display area Ac, and an advertisement.

The electronic receipt image Imb includes the selected receipt display area Ab, the receipt detail display area Ac, a company-specific advertisement display area Ad, and a common advertisement display area Ae. The selected receipt display area Ab is for displaying an overview of the receipt selected from the receipt list image. The receipt detail display area Ac is an area for displaying detailed information of the selected receipt. The detailed information of the receipt is, for example, information related to details of the transaction. In the depicted example, the selected receipt display area Ab and the receipt detail display area Ac are displayed as an electronic receipt.

The company-specific advertisement display area Ad is for displaying a company-specific advertisement. The company-specific advertisement display area Ad displays, for example, a company-specific advertisement as set by the retailer. The common advertisement display area Ae is for displaying a common advertisement. For example, the company-specific advertisement display area Ad is displayed above (that is, nearer the top of the receipt) the common advertisement display area Ae. In the example, in addition to the electronic receipt, the company-specific advertisement display area Ad and the common advertisement display area Ae are displayed with different advertisements.

According to the present example, the user terminal 2 can display an advertisement for a particular company on the electronic receipt based on the advertisement setting information associated with the electronic receipt code or the like. In other words, the receipt detail display area Ac with the detailed transaction information and the company-specific advertisement display area Ad with the company-specific advertisement are displayed in a visible manner. Therefore, the user can receive an advertisement from the retailer associated with the particular electronic receipt. The retailer can thus distribute sales promotion information (specifically related to the retailer) on a browsing screen on which the electronic receipt is viewed by the customer. As such, the user terminal 2 can display a company-specific advertisement in a display area on the electronic receipt different from that of a common advertisement. Therefore, the user may pay more attention to the company-specific advertisement. In some examples, the retailer can enhance an effect of the advertisement by making the company-specific advertisement more noticeable than the common advertisement by adoption of various display modes or the like.

### Modification

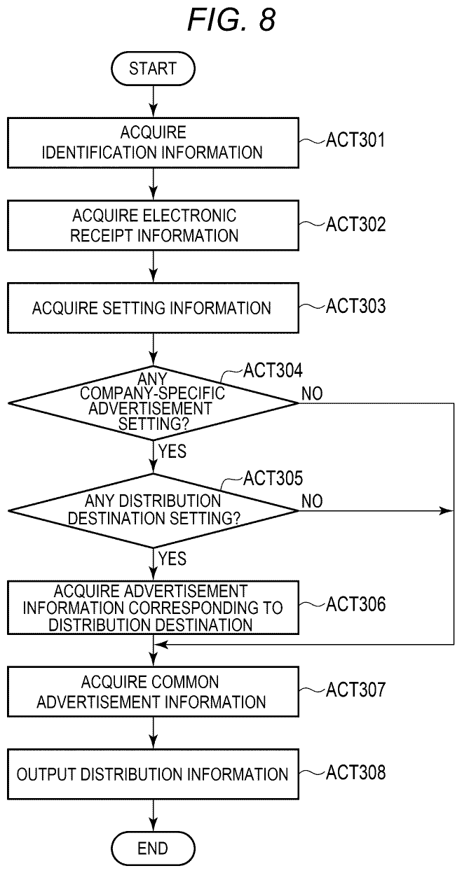

FIG. 8 is a flowchart showing a modification of electronic receipt distribution processing performed by a server 1 according to an embodiment.

In an embodiment, server 1 performs the advertisement distribution processing based on company-specific settings for each advertisement, but the present disclosure is not limited thereto. In a modification, the server 1 sets whether to provide a company-specific advertisement or not according the output destination for a requested electronic receipt and thus performs advertisement distribution processing based on the settings related to the output destination.

In an example, the advertisement setting information includes setting information related to an output destination. The setting processing unit 111 of the server 1 may acquire such setting information related to the output destination from the setter terminal 3. The setting information related to an output destination includes, for example, information for identifying the output destination. The information identifying the output destination includes at least one of a member rank, an address, a gender, and a family structure. For example, if the output destination is associated with a member rank, the information identifying the output destination may include a type/level of member rank. If the output destination is associated with an address, the information identifying the output destination may include information indicating a geographic distribution area or the like. If the output destination is associated with a gender, the information identifying the output destination may include information indicating preferred distribution to males or females. If the output destination is associated with a family structure, the information identifying the output destination may include information such as whether the advertisement is to be distributed to a single-person household, a married couple household, or whether the household has children.

The output unit 112 of the server 1 may output the advertisement display data to the user terminal 2 of the user matching the output destination characteristics set based on the setting information related to the output destination.

Similarly to ACT201, the processing circuit 11 acquires identification information (ACT301). The ACT301 processing may be performed by the output unit 112 implemented by the processing circuit 11. In ACT301, the processing circuit 11 acquires the user ID and the electronic receipt number of the electronic receipt requester from the server 1 based on the receipt display command. The processing circuit 11 also acquires the company code from the server 1.

Similarly to ACT202, the processing circuit 11 acquires the electronic receipt information based on the electronic receipt number (ACT302). The ACT302 processing may be performed by the output unit 112 implemented by the processing circuit 11. In ACT302, the processing circuit 11 acquires the electronic receipt information as identified by the electronic receipt number from the electronic receipt information memory area 131.

Similarly to ACT203, the processing circuit 11 also acquires the advertisement setting information (ACT303). The ACT303 processing may be performed by the output unit 112 implemented by the processing circuit 11. In ACT303, the processing circuit 11 acquires the advertisement setting information from the setting information memory area 134 for the retailer identified by the company code.

Similarly to ACT204, the processing circuit 11 determines whether a company-specific advertisement setting was performed based on the advertisement setting information (ACT304). The ACT304 processing may be performed by the output unit 112 implemented by the processing circuit 11. In ACT304, if the company-specific advertisement setting indicates that a company-specific advertisement is to be output, the processing circuit 11 determines that the company-specific advertisement setting was made. If the company-specific advertisement setting does not indicate that a company-specific advertisement is to be output, the processing circuit 11 determines that the company-specific advertisement setting was not made.

If the company-specific advertisement setting was made (ACT304: YES), the processing transitions from ACT304 to ACT305. If the company-specific advertisement setting was not made (ACT304: NO), the processing transitions from ACT304 to ACT307.

The processing circuit 11 then determines whether output destination characteristic have been set based on the fact that the company-specific advertisement setting was made (ACT305). The ACT305 processing may be performed by the output unit 112 implemented by the processing circuit 11. In ACT305, the processing circuit 11 refers to the advertisement setting information and determines whether any settings related to the output destination have been made. If the information identifying characteristics of the output destination have been set, the processing circuit 11 determines that an output destination has been set. If the information identifying characteristic of the output destination have not been set, the processing circuit 11 determines that output destination characteristics have not been set.

When the output destination characteristics are set (ACT305: YES), the processing transitions from ACT305 to ACT306. When the output destination characteristics are not set (ACT305: NO), the processing transitions from ACT305 to ACT307. Similarly, if a company-specific advertisement setting was not made (ACT304: NO), the processing transitions from ACT304 to ACT307.

The processing circuit 11 acquires the company-specific advertisement information for an output destination (ACT306). The ACT306 processing may be performed by the output unit 112 implemented by the processing circuit 11. In ACT306, the processing circuit 11 refers to the advertisement setting information and acquires the advertisement identification information of a company-specific advertisement for the particular characteristics of an output destination for the electronic receipt. The processing circuit 11 acquires, based on the advertisement identification information, the advertisement information corresponding to the advertisement identification information for an output destination from the advertisement information memory area 133. For example, the processing circuit 11 acquires company-specific advertisement image data for an output destination type or the like.

For example, the processing circuit 11 identifies the advertisement to be distributed to a user based on the information associated with the output destination (e.g., a particular user). A case in which the information related to the output destination is a member rank will be described as an example. The processing circuit 11 acquires user information from the user information memory area 132 based on a member ID associated with the requested electronic receipt or the like. The processing circuit 11 identifies, based on this user information, a company-specific advertisement to be distributed to a member rank matching that of the user of the user terminal 2. The processing circuit 11 thus acquires the advertisement identification information of a company-specific advertisement to be distributed to the user of the user terminal 2 according to member rank. The processing circuit 11 acquires the advertisement information corresponding to the advertisement identification information of a company-specific advertisement to be distributed to the user of the user terminal 2, then cause the company-specific advertisement to be displayed to the user.

When the information identifying the output destination indicates that the users to whom the advertisement is to be distributed is limited in some manner, the processing circuit 11 may acquire advertisement information corresponding to a company-specific advertisement only when the user of the user terminal 2 is included in the users to whom the advertisement is to be distributed.

Similarly to ACT206, the processing circuit 11 acquires common advertisement information (ACT307). The ACT307 processing may be performed by the output unit 112 implemented by the processing circuit 11. In ACT307, the processing circuit 11 acquires the common advertisement information from the advertisement information memory area 133.

Similarly to ACT207, the processing circuit 11 outputs the distribution information to the user terminal 2 via the communication interface 14 (ACT308). The ACT308 processing may be performed by the output unit 112 implemented by the processing circuit 11. In ACT308, the processing circuit 11 outputs the electronic receipt information to the user terminal 2. The processing circuit 11 outputs the advertisement display data to be displayed on the electronic receipt to the user terminal 2. For example, when the output of company-specific advertisement is enabled, the processing circuit 11 outputs company-specific advertisement image data and common advertisement image data to the user terminal 2. When the output of company-specific advertisement is disabled, the processing circuit 11 outputs just the common advertisement image data to the user terminal 2.

Accordingly, the server 1 can perform a setting related to the output destination and output particular advertisement display data based on the settings related to the output destination. As such, setting information for identifying an output destination in addition to advertisement setting information for different companies can be set in the server 1. The server 1 may then output a company-specific advertisement image selected based on output destination (e.g., user characteristics) for inclusion in an electronic receipt to the user terminal 2. Accordingly, the server 1 can distribute advertisements desired by a company adopting the electronic receipt service in a further particularized manner for different customers or the like.

### OTHER EMBODIMENTS

Each unit described as implemented by the processing circuit 11 above is not limited to being implemented by a single device or the same device such as the server 1. These units may be distributed among a plurality of devices. In this case, the plurality of devices is an example of an information processing device.

An embodiment includes a method executed by a device as described above. An embodiment includes a program enabling a computer or other device to execute each function as described above. An embodiment may be a recording medium that stores a program as described above.

A program of an embodiment may be transferred already stored in a device according to an embodiment or separately from the device. In the latter case, the program may be transferred via a network recorded on a recording medium. The recording medium may be a non-transitory tangible medium. The recording medium can be any computer-readable medium. A format of the recording medium is not limited as long as the recording medium can store a program and be read by a computer, such as a CD-ROM or a memory card.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. An electronic receipt server, comprising:
a communication interface connectable to a network;
a storage device; and
a processing circuit configured to:
receive advertisement setting information from a setter terminal via the communication interface;
store the advertisement setting information in the storage device;
store electronic receipt information in the storage device;
receive a request for an electronic receipt from a user terminal via the communication interface;
identify a company code associated with the requested electronic receipt;
acquire the advertisement setting information associated with the company code in the storage device;
determine whether the advertisement setting information indicates company-specific advertisements are enabled for the company code;
acquire a company-specific advertisement when the advertisement information indicates company-specific advertisements are enabled for the company code; and
output the acquired company-specific advertisement with the electronic receipt to the user terminal via the communication interface.

2. The electronic receipt server according to claim 1, wherein the processing circuit is further configured to:
acquire a shared advertisement; and
output the acquired shared advertisement with the electronic receipt to the user terminal via communication interface.

3. The electronic receipt server according to claim 2, wherein the shared advertisement and the company-specific advertisement are both shown on the electronic receipt.

4. The electronic receipt server according to claim 3, wherein the shared advertisement and the company-specific advertisement are displayed in different modes.

5. The electronic receipt server according to claim 3, wherein the company-specific advertisement is displayed in a highlighted manner distinct from the shared advertisement manner of display.

6. The electronic receipt server according to claim 1, wherein the processing circuit is further configured to:
obtain user characteristics associated with the request for the electronic receipt; and
determine whether the advertisement setting information includes user characteristic settings, wherein
the company-specific advertisement is acquired based on an obtained user characteristic and the user characteristic settings in the advertisement setting information.

7. The electronic receipt server according to claim 6, wherein the user characteristic is a store membership level.

8. The electronic receipt server according to claim 1, wherein the company-specific advertisement is stored in the storage device.

9. The electronic receipt server according to claim 1, wherein the request for the electronic receipt from the user terminal is sent from a store-specific shopping application.

10. The electronic receipt server according to claim 1, wherein the request for the electronic receipt from the user terminal is sent from an electronic receipt service application.

11. An electronic receipt system, comprising:
a setter terminal;
a user terminal; and
an electronic receipt server, the electronic receipt server includes:
a communication interface connected to the setter terminal and the user terminal via a network;
a storage device; and
a processing circuit configured to:
receive advertisement setting information from the setter terminal via the communication interface;
store the advertisement setting information in the storage device;
store electronic receipt information in the storage device;
receive a request for an electronic receipt from the user terminal via the communication interface;
identify a company code associated with the requested electronic receipt;
acquire the advertisement setting information associated with the company code in the storage device;
determine whether the advertisement setting information indicates company-specific advertisements are enabled for the company code;
acquire a company-specific advertisement when the advertisement information indicates company-specific advertisements are enabled for the company code; and
output the acquired company-specific advertisement with the electronic receipt to the user terminal via the communication interface.

12. The electronic receipt system according to claim 11, wherein the processing circuit is further configured to:
acquire a shared advertisement; and
output the acquired shared advertisement with the electronic receipt to the user terminal via communication interface.

13. The electronic receipt system according to claim 12, wherein the shared advertisement and the company-specific advertisement are both shown on the electronic receipt.

14. The electronic receipt system according to claim 11, wherein the request for the electronic receipt from the user terminal is sent from a store-specific shopping application executing on the user terminal.

15. The electronic receipt system according to claim 11, wherein the request for the electronic receipt from the user terminal is sent from an electronic receipt service application executing on the user terminal.

16. An electronic receipt advertisement serving method, comprising:
receiving advertisement setting information from a setter terminal via a communication interface;
storing the advertisement setting information in a storage device;
storing electronic receipt information in the storage device;
receiving a request for an electronic receipt from a user terminal via the communication interface;
identifying a company code associated with the requested electronic receipt;
acquiring the advertisement setting information associated with the company code in the storage device;
determining whether the advertisement setting information indicates company-specific advertisements are enabled for the company code;
acquiring a company-specific advertisement when the advertisement indicates information company-specific advertisements are enabled for the company code; and
outputting the acquired company-specific advertisement with the electronic receipt to the user terminal via the communication interface.

17. The electronic receipt advertisement serving method according to claim 16, further comprising:
acquiring a shared advertisement; and
outputting the acquired shared advertisement with the electronic receipt to the user terminal via communication interface.

18. The electronic receipt advertisement serving method according to claim 17, wherein the shared advertisement and the company-specific advertisement are both shown on the electronic receipt.

19. The electronic receipt advertisement serving method according to claim 16, further comprising:
obtaining user characteristics associated with the request for the electronic receipt; and
determining whether the advertisement setting information includes user characteristic settings, wherein
the company-specific advertisement is acquired based on an obtained user characteristic and the user characteristic settings in the advertisement setting information.

20. The electronic receipt advertisement serving method according to claim 16, wherein the request for the electronic receipt from the user terminal is sent from a store-specific shopping application.
